(19) United States
(12) Patent Application Publication
(10) Pub. No.: US 2026/0150996 A1
(43) Pub. Date: Jun. 4, 2026

(54) ADAPTIVE COFFEE SUPPLY SYSTEM AND METHOD THEREOF

(71) Applicant: Asia Eastern University of Science and Technology, NEW TAIPEI CITY (TW)

(72) Inventor: PENG-WEN CHEN, New Taipei City (TW)

(21) Appl. No.: 19/347,675

(22) Filed: Oct. 1, 2025

(30) Foreign Application Priority Data
Oct. 8, 2024 (TW) 113138179

(51) Int. Cl. A47J 31/52; A47J 31/44

(52) U.S. Cl. CPC A47J 31/52; A47J 31/4492

(57) ABSTRACT

An adaptive coffee supply system and method thereof. The method includes: loading an adaptive flavor table, which includes a plurality of flavor data; displaying the adaptive flavor table on an operating interface, and selecting at least two of the flavor data as designated flavor data; weighting the designated flavor data to obtain target flavor scores; loading a plurality of coffee data, each of the coffee data is correspond to a type of coffee grounds and includes flavor density data; selecting at least two of the coffee data as output coffee data to ensure the two flavor density data correspond to the designated flavor data and defined as harmonized flavor density data; and calculating formula output data according to the target flavor scores, so that a product of the formula output data and each of the harmonized flavor density data is equal to the target flavor scores.

### CROSS-REFERENCE TO RELATED PATENT APPLICATION

This application claims the benefit of priority to Taiwan Patent Application No. 113138179, filed on Oct. 8, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a system, and more particularly to an adaptive coffee supply system and method thereof.

### BACKGROUND OF THE DISCLOSURE

In the conventional technology, coffee supply systems on the market typically employ fixed brewing parameters, such as water temperature, extraction time, grind size, and the ratio of coffee grounds to water, in order to provide standardized coffee. However, these coffee supply systems cannot dynamically adjust brewing conditions according to flavor preferences of individual users to achieve personalized coffee flavors. For example, some users prefer a fruity acid flavor with berry notes, while others favor coffee with rich caramel or nutty flavors. The conventional coffee supply system often only provides limited preset options and cannot precisely control the brewing process according to the characteristics of different coffee beans and user requirements to optimize the expression of specific flavors.

### SUMMARY OF THE DISCLOSURE

In response to the above-referenced technical inadequacy, the present disclosure provides an adaptive coffee supply system and method thereof in view of the problems in the conventional technology.

In order to solve the above-mentioned problems, one of the technical aspects adopted by the present disclosure is to provide an adaptive coffee supply system. The adaptive coffee supply system includes a database, an operating interface, a comparing module, a calculating module, and a communication module. The database includes an adaptive flavor table and a plurality of coffee data. The adaptive flavor table includes a plurality of different flavor data. The coffee data includes a plurality of flavor density data corresponding to the flavor data. The operating interface is electrically coupled to the database. The operating interface is configured to selectively output at least two of the flavor data and is configured to respectively define the flavor data as two designated flavor data, and the operation interface is configured to weight the two designated flavor data to obtain two target flavor scores. The comparing module is electrically coupled to the operating interface and the database. The comparing module is configured to compare the coffee data according to the two designated flavor data to select at least two of the coffee data to be defined as two output coffee data. Two of the flavor density data included in the two output coffee data correspond to the two designated flavor data and are defined as two harmonized flavor density data. The calculating module is electrically coupled to the comparing module. The calculating module is configured to calculate a formula output data of the two harmonized flavor density data in the two output coffee data according to the two target flavor scores, and a product of the formula output data and each of the harmonized flavor density data is equal to the target flavor score. The communication module is electrically coupled to the calculating module. The communication module is configured to transmit the two output coffee data and the two formula output data to a manufacturing equipment for producing an adaptive coffee.

In order to solve the above-mentioned problems, another one of the technical aspects adopted by the present disclosure is to provide an adaptive coffee supply method. The adaptive coffee supply method includes: loading an adaptive flavor table, wherein the adaptive flavor table includes a plurality of different flavor data; displaying the adaptive flavor table on an operating interface, and selecting at least two of the flavor data via the operating interface to respectively define the flavor data as two designated flavor data; weighting the two designated flavor data to obtain two target flavor scores; loading a plurality of coffee data, each of the coffee data being configured to correspond to a type of coffee grounds, wherein the coffee data includes a plurality of flavor density data corresponding to the flavor data; selecting at least two of the coffee data to be defined as two output coffee data, wherein two of the flavor density data included in the two output coffee data correspond to the two designated flavor data and are defined as two harmonized flavor density data; calculating a formula output data of the two harmonized flavor density data in the two output coffee data according to the two target flavor scores, and a product of the formula output data and each of the harmonized flavor density data is equal to the target flavor score; and manufacturing an adaptive coffee according to the two output coffee data and the two formula output data.

Therefore, in the adaptive coffee supply system and method thereof provided by the present disclosure, by virtue of “the calculating module being configured to calculate a formula output data of the two harmonized flavor density data in the two output coffee data according to the two target flavor scores, and a product of the formula output data and each of the harmonized flavor density data being equal to the target flavor score,” and “the communication module being configured to transmit the two output coffee data and the two formula output data to a manufacturing equipment for producing an adaptive coffee,” the adaptive coffee supply system and method thereof can provide the adaptive coffee according to a drinker's taste.

Furthermore, in the adaptive coffee supply system and method thereof provided by the present disclosure, a capsule coffee machine is further included, and by virtue of “the control module being further configured to brew the first coffee capsule with a first liquid having a first predetermined condition according to the concentrate control command to generate a coffee concentrate having a standard concentration corresponding to the standard concentration data,” and “the control module being configured to input a second liquid having a second predetermined condition into the coffee concentrate according to the concentration adjustment data to generate an optimal-concentration beverage liquid,” the capsule coffee machine can provide coffee with an optimal concentration based on individual needs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic circuit block diagram of an adaptive coffee supply system according to the present disclosure;

FIG. 2 is a schematic planar view of an operation interface according to the present disclosure;

FIG. 3 is another schematic planar view of the operation interface according to the present disclosure;

FIG. 4 is a flowchart of an adaptive coffee supply method according to the present disclosure;

FIG. 5 is a schematic perspective view of a capsule coffee machine according to the present disclosure;

FIG. 6 is a schematic circuit block diagram of the capsule coffee machine according to the present disclosure;

FIG. 7 is a schematic view showing an operational state of the capsule coffee machine according to the present disclosure;

FIG. 8 is a schematic view showing another operational state of the capsule coffee machine according to the present disclosure;

FIG. 9 is a schematic view showing yet another operational state of the capsule coffee machine according to the present disclosure;

FIG. 10 is a schematic view showing still another operational state of the capsule coffee machine according to the present disclosure;

FIG. 11 is a schematic view showing still another operational state of the capsule coffee machine according to the present disclosure; and

FIG. 12 is a flowchart of a brewing and management method according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### First Embodiment

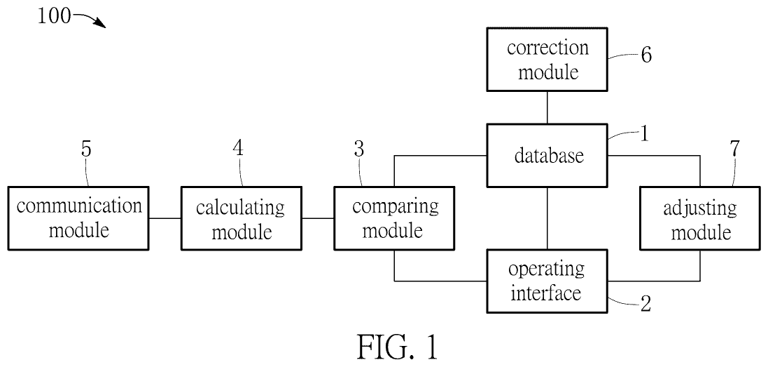

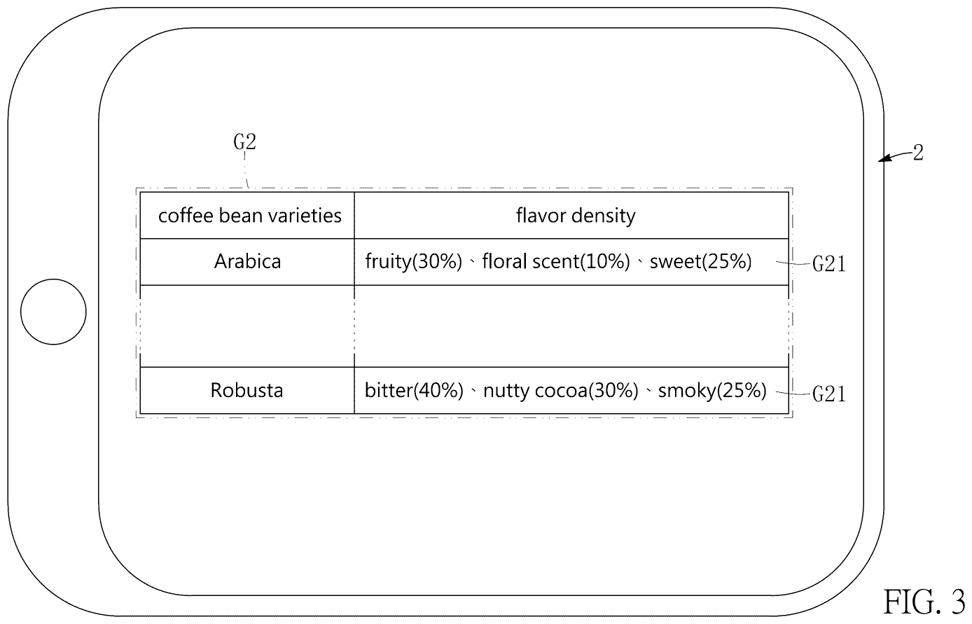

Referring to FIG. 1 to FIG. 3, a first embodiment of the present disclosure provides an adaptive coffee supply system 100. The adaptive coffee supply system 100 is configured to provide an adaptive coffee (e.g., capsule coffee, coffee grounds) to the drinker according to a taste of the drinker. In practice, the adaptive coffee provided by the adaptive coffee supply system 100 can be made using manufacturing equipment of the manufacturer, meaning that the adaptive coffee supply system 100 does not involve manufacturing. That is to say, the adaptive coffee supply system 100 can also be embedded into coffee machines (e.g., the capsule coffee machine) for use, or used collaboratively across multiple devices (e.g., devices belonging to the manufacturer and the consumer).

As shown in FIG. 1, the adaptive coffee supply system 100 includes a database 1, an operating interface 2 that is electrically coupled to the database 1, a comparing module 3 that is electrically coupled to the operating interface 2 and the database 1, a calculating module 4 that is electrically coupled to the comparing module 3, and a communication module 5 that is electrically coupled to the calculating module 4.

Referring to FIG. 1 to FIG. 3, the database 1 includes an adaptive flavor table G1 and a plurality of coffee data G2. The adaptive flavor table G1 includes a plurality of different flavor data G11. The coffee data G2 includes a plurality of flavor density data G21 corresponding to the flavor data G11.

In practice, the database 1 can be pre-written with the adaptive flavor table G1 and the plurality of coffee data G2, or connected to a cloud through the Internet to retrieve the adaptive flavor table G1 and the plurality of coffee data G2.

Furthermore, the adaptive flavor table G1 can be understood as a table used to describe flavor of coffee, and the adaptive flavor table G1 has multiple different flavor descriptions (i.e., the flavor data G11), such as fruity, floral, sweet, etc.

The coffee data G2 can be understood as multiple different coffees corresponding to different varieties, origins, processing methods, roasting degrees, and flavor characteristics. Each of coffees is carefully analyzed to determine the different flavor proportions per unit weight. For example, the coffee data G2 of light roasted Arabica has three flavors: fruity, floral, and sweet. The three flavors have a per unit weight proportion of 30%, 10%, and 25%, respectively. In other words, the coffee data G2 has three of the flavor density data G21.

Referring to FIG. 1 to FIG. 3, the operating interface 2 can be a touch panel in practice, and the operating interface 2 is configured to selectively output at least two of the flavor data G11 and is configured to respectively define the flavor data as two designated flavor data. In addition, the operation interface 2 is configured to weight the two designated flavor data to obtain two target flavor scores.

In other words, the drinker can view the adaptive flavor table G1 through the operating interface 2, and further select several of the flavor data G11 as the designated flavor data (e.g., fruity, floral) according to preferences of the drinker. The present embodiment uses two of the designated flavor data for description, but the present disclosure is not limited thereto. In addition, the drinker can strengthen the weight of two of the designated flavor data to obtain the two target flavor scores.

For example, two of the designated flavor data G11 respectively correspond to a fruity flavor and a floral flavor, and definition scores of the two designated flavor data G11 are 100. Weight of the fruity flavor is 25%, and weight of the floral flavor is 75%. That is to say, the two target flavor scores are 25 points and 75 points.

Preferably, the operating interface 2 is configured to arrange the flavor data G11 in a circular shape according to a sensory similarity, a chemical similarity, and an extraction-and-perception sequence, but the present disclosure is not limited thereto.

As shown in FIG. 1 to FIG. 3, the comparing module 3 is configured to compare the coffee data G2 according to the two designated flavor data G11 to select at least two of the coffee data G2 to be defined as two output coffee data G2. Wherein two of the flavor density data G21 are included in the two output coffee data G2 correspond to the two designated flavor data G11 and are defined as two harmonized flavor density data G21.

For example, the two designated flavor data G11 that correspond to a fruity flavor and a nutty flavor, respectively, are selected by the drinker. The comparing module 3 selects two of the coffee data G2 having the flavor density data G21 corresponding to the fruity flavor and the nutty flavor from the coffee data G2 as the output coffee data G2.

It should be noted that, in practice, the flavor density data G21 of each of the output coffee data G2 can match at least one of the two designated flavor data G11, but the flavor density data G21 included in the two output coffee data G2 must be able to match with two designated flavor data G11.

As shown in FIG. 1 to FIG. 3, the calculating module 3 is configured to calculate a formula output data of the two harmonized flavor density data G21 in the two output coffee data G2 according to the two target flavor scores, and a product of the formula output data and each of the harmonized flavor density data G21 is equal to the target flavor score.

For example, the two output coffee data G2 are respectively defined as a first output coffee data G2 corresponding to light roasted Arabica, and a second output coffee data G2 corresponding to dark roasted Robusta. The first output coffee data G2 has three of first flavor density data, which are fruity (30%), floral (10%), and sweet (25%). The second output coffee data G2 has three of second flavor density data, which are bitter (40%), nutty cocoa (30%), and smoky (25%). The drinker establishes the two target flavor scores through the operating interface 2, and the two target flavor scores are 25 points for fruity flavor and 75 points for nutty cocoa.

Therefore, for an adaptive coffee of a predetermined weight (e.g., 100 grams), the calculating module 4 can calculate that the formula output data corresponding to the fruity flavor should be approximately 83.3 grams, and the formula output data corresponding to the nutty cocoa flavor should be approximately 16.7 grams, so that the adaptive coffee has a 25% fruity flavor and a 75% nutty cocoa flavor.

The formula output data corresponding to the fruity flavor and the formula output data corresponding to the nutty cocoa flavor can be as follows:

X is a ratio of coffee grounds corresponding to the first output coffee data G2 and is preset to account for 100 g of a total. Y is a ratio of coffee grounds corresponding to the second output coffee data G2. Therefore, a relationship Y=1−X can be obtained (the total amount is 100 g).

A fruit aroma content of the coffee grounds corresponding to the first output coffee data G2 is 30% (i.e., 0.30), and a fruit aroma content of the coffee grounds corresponding to the second output coffee data G2 is 0% (because it does not contain fruit aroma components). A nut cocoa content of the coffee grounds corresponding to the first output coffee data G2 is 0% (because it does not contain nut cocoa components), and a nut cocoa content corresponding to the second output coffee data G2 is 30% (i.e., 0.30).

For the fruity aroma content, the adaptive coffee is expected to reach 25%, and the formula is as follows:
0.30×X+0×(1−X)=0.25.
0.30×X=0.25.
X=0.25/0.30=0.833.

Therefore, by substituting X=0.8333 into the relation Y=1−X, Y is obtained as 0.1667. That is to say, in 100 grams, the coffee grounds corresponding to fruity flavor should be about 83.3 grams, and the coffee grounds corresponding to nutty-cocoa flavor should be about 16.7 grams.

In practice, a flavor proportion of the coffee data (i.e., the flavor density data) can be loaded through experts or publicly available information.

More specifically, each of the flavor density data G21 includes a flavor identity corresponding to the flavor data G11 and a proportion coefficient value. The comparing module 3 is configured to select the coffee data G2 according to whether the flavor identity matches the designated flavor data G11, and the calculating module 4 is configured to obtain the formula output data as a quotient value of the target flavor score and the proportion coefficient value.

In order to ensure that the calculating module 4 can compute the formula output data more efficiently and save computing costs, the proportion coefficient values of the flavor density data G21 can be preset to 1. That is to say, although there are two flavors with different proportions in the coffee powder, they are both set with the same proportion. This is suitable for drinkers who prefer low-end machines and are not sensitive to taste.

Furthermore, in addition to obtaining the flavor proportions of the coffee data G2 through publicly available information, the adaptive coffee supply system 100 can also analyze the flavor proportions through existing chemical characteristics. More specifically, the adaptive coffee supply system 100 further includes a correction module 6 that is connected to the database 1, each of the coffee data G2 further includes a volatile organic compound value and an ion value, and the correction module is configured to correct the proportion coefficient value according to the volatile organic compound value and the ion value of each of the coffee data G2.

It should be noted that, in order to allow the drinker to more quickly select his favorite flavor in the operating interface 2, the adaptive coffee supply system 100 further includes an adjusting module 7 that is electrically coupled to the database 1 and the operating interface 2. The adjusting module 7 is configured to classify the flavor data G11 according to a sensory similarity, a chemical similarity, and an extraction-and-perception sequence, and the adjusting module 7 is configured to exclude the flavor data G11 having mutually exclusive characteristics according to the two designated flavor data, so as to adjust the adaptive flavor table G1.

For example, the fruity flavor forms a stronger contrast or repulsion compared to bitterness. This is because fruity notes are usually characterized by bright, sweet-and-sour attributes, whereas bitterness originates from deep roasting, caramelization, or the rich body of coffee. These characteristics may mask or diminish the delicacy of fruity aromas.

It should be noted that, although the adaptive coffee supply system 100 of the present disclosure is described in the present embodiment by mixing two types of coffee grounds, it is also possible to mix one type of coffee grounds with one type of tea to obtain the adaptive coffee.

### Second Embodiment

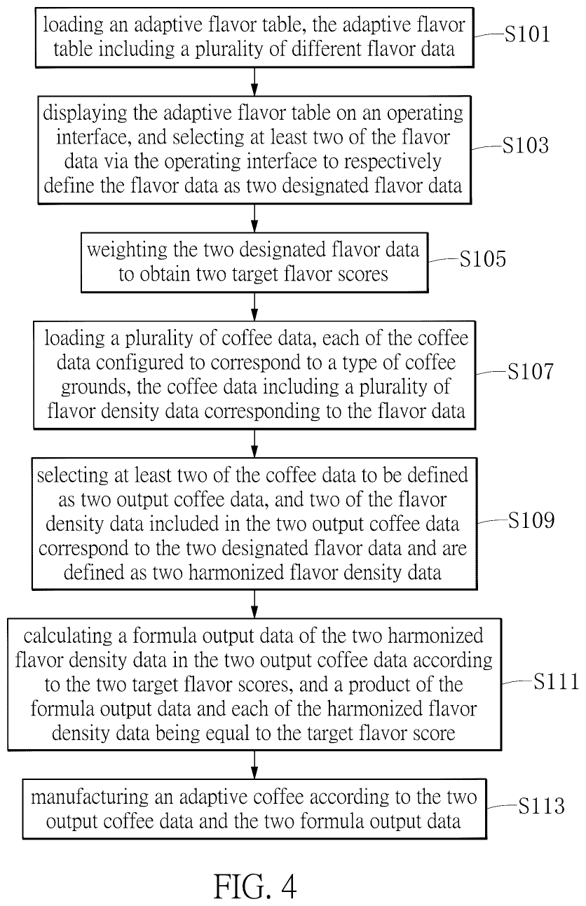

Referring to FIG. 4, the present embodiment provides an adaptive coffee supply method, which can be applied to the adaptive coffee supply system of the first embodiment or to any other adaptive coffee supply system. The adaptive coffee supply method includes steps S101 to S113.

Step S101: loading an adaptive flavor table, the adaptive flavor table including a plurality of different flavor data.

Step S103: displaying the adaptive flavor table on an operating interface, and selecting at least two of the flavor data via the operating interface to respectively define the flavor data as two designated flavor data.

Step S105: weighting the two designated flavor data to obtain two target flavor scores.

Step S107: loading a plurality of coffee data, each of the coffee data configured to correspond to a type of coffee grounds, the coffee data including a plurality of flavor density data corresponding to the flavor data.

Step S109: selecting at least two of the coffee data to be defined as two output coffee data, and two of the flavor density data included in the two output coffee data correspond to the two designated flavor data and are defined as two harmonized flavor density data.

Step S111: calculating a formula output data of the two harmonized flavor density data in the two output coffee data according to the two target flavor scores, and a product of the formula output data and each of the harmonized flavor density data being equal to the target flavor score.

Step S113: manufacturing an adaptive coffee according to the two output coffee data and the two formula output data.

In practice, the operating interface is configured to arrange the flavor data in a circular shape according to a sensory similarity, a chemical similarity, and an extraction-and-perception sequence.

In addition, in order to allow the drinker to more quickly select his favorite flavor in the operating interface 2, the adaptive coffee supply method is configured to classify the flavor data according to a sensory similarity, a chemical similarity, and an extraction-and-perception sequence, and excluding the flavor data having mutually exclusive characteristics according to the two designated flavor data, so as to adjust the adaptive flavor table.

### Third Embodiment

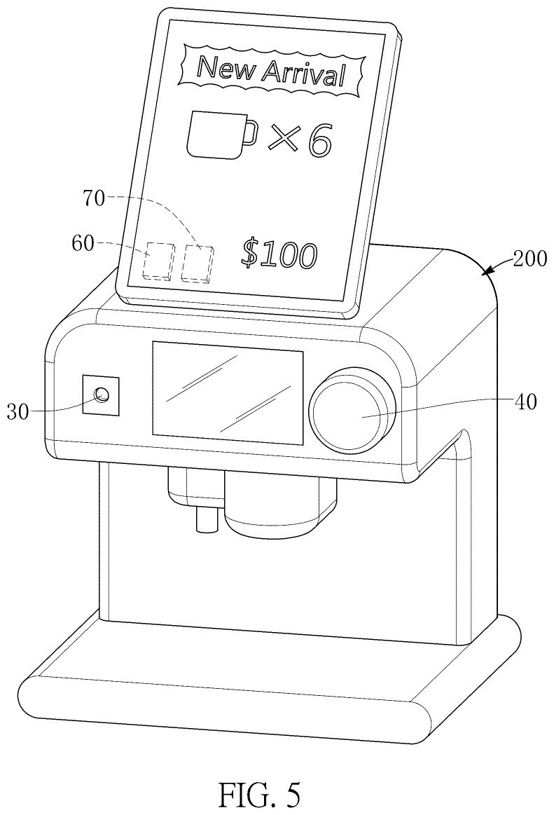

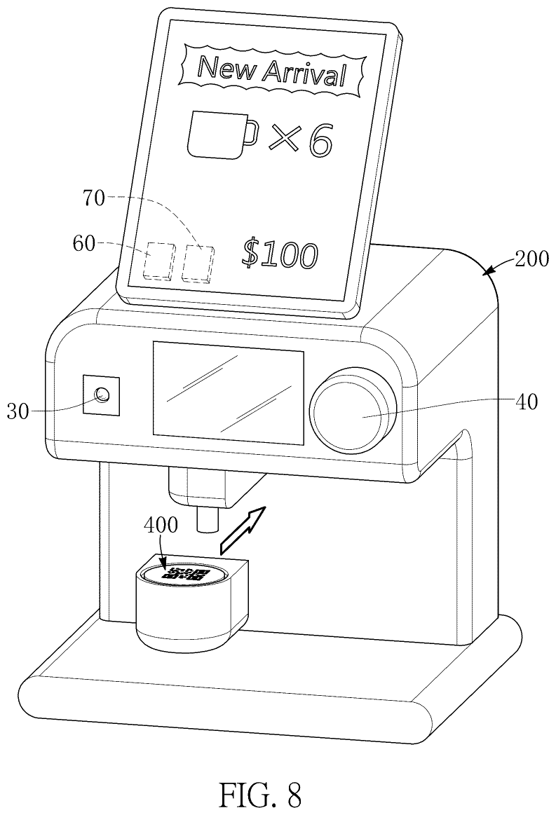

Referring to FIG. 5 to FIG. 11, the present embodiment provides a capsule coffee machine 200 that supports personal comfortable flavor. As shown in FIG. 5 to FIG. 7, the capsule coffee machine 200 is configured to brew a first coffee capsule 400, and the capsule coffee machine 200 can avoid over-brewing the coffee grounds in the first coffee capsule 400, which causes the release of unintended substances in the coffee grounds into the coffee liquid and affects the flavor. In other words, the coffee grounds reach their maximum concentration in the optimal state. At the same time, the capsule coffee machine 200 can also adjust the concentration of the coffee liquid according to personal preferences without affecting the flavor, so as to better suit personal preferences.

That is to say, the capsule coffee machine 200 of the present disclosure can first output an appropriate amount of liquid (e.g., water) according to the amount and type of coffee grounds in the first coffee capsule 400 to ensure the flavor of the coffee liquid, and then output a second amount of liquid (without coffee grounds) to adjust the concentration of the coffee liquid according to personal preference. Therefore, any of the capsule coffee machine that does not output liquid for brewing coffee powder in the first step and output liquid for adjusting the concentration of the coffee liquid in the second step is not the capsule coffee machine 200 referred to in the present disclosure.

Referring to FIG. 5 to FIG. 7, the capsule coffee machine 200 includes an expert data module 10, an adjustment data module 20, an identification module 30 that is electrically coupled to the expert data module 10, and a control module 40 that is electrically coupled to the identification module 30 and the adjustment data module 20. Next, the components of the capsule coffee machine 200 and their connection relationships are introduced below.

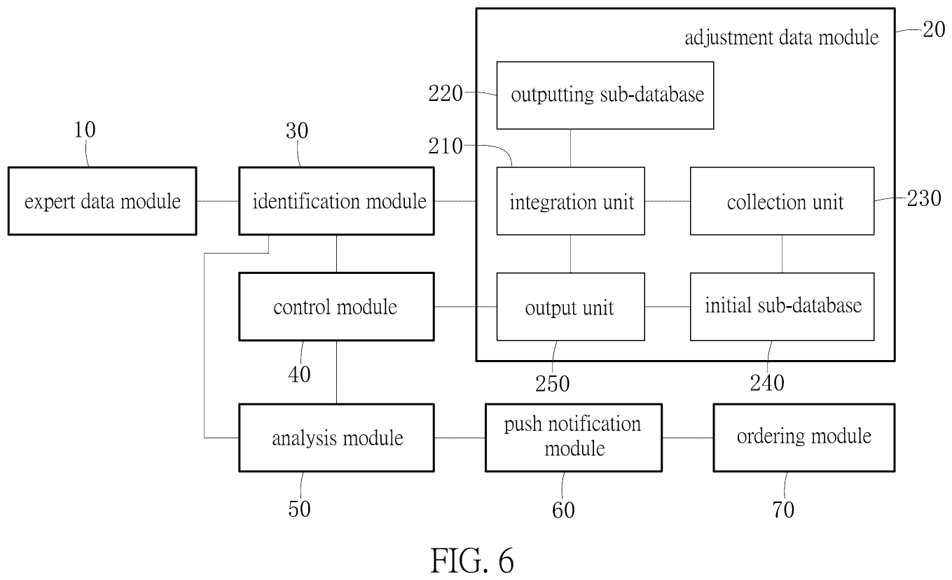

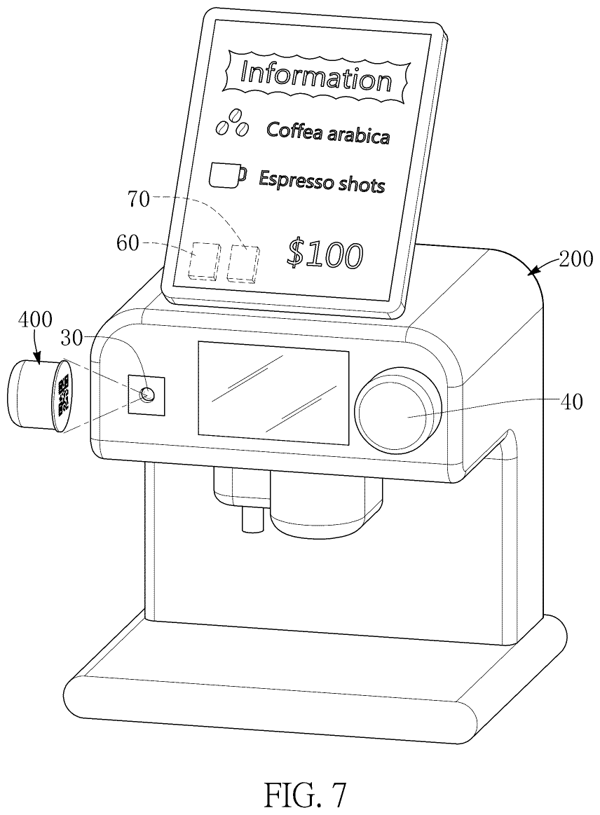

As shown in FIG. 6 and FIG. 7, the expert data module 10 includes a plurality of capsule identity data, a plurality of concentrate control commands respectively corresponding to the capsule identity data, and a plurality of standard concentration data respectively corresponding to the capsule identity data. Wherein each of the capsule identity data can correspond to a first coffee capsule, and each of the first coffee capsule has the independent concentrate control commands and the standard concentration data. The concentrate control command is a most suitable brewing condition (e.g., water volume, pressure, water temperature, time, etc.) for the first coffee capsule 400, and the standard concentration data is a concentration pre-measured when the first coffee capsule 400 is actually brewed using the aforementioned brewing conditions (i.e., the standard concentration data is pre-recorded data).

It should be noted that, different styles of the first coffee capsules contain different types of coffee beans and coffee grounds weight. Therefore, a barista adjusts the brewing conditions in advance according to different types of the first coffee capsule to achieve optimal flavor, thereby establishing the concentrate control command. Furthermore, the concentration of the first coffee capsule 400 after brewing under the aforementioned brewing conditions is also recorded and established as the standard concentration data for personalized use by the capsule coffee machine 200.

In other words, the soluble solids in coffee grounds account for approximately 30%. Therefore, when the coffee grounds become saturated during brewing, any subsequent brewing actions will only degrade the flavor. Furthermore, although the brewed coffee grounds have not become saturated, different coffee grounds require different suitable brewing conditions such as temperature, pressure, and time. These variations affect the substances released into the coffee liquid, thereby influencing the flavor. Therefore, the expert data module 10 is a professional brewing database pre-established from the perspective of the barista based on different first coffee capsules to ensure that the capsule coffee machine 200 can provide an ideal coffee concentrate.

Naturally, the expert data module 10 can be connected to the cloud for real-time updating to add or modify the capsule identity data, the concentrate control command and the standard concentration data, and is not described herein for the sake of brevity.

As shown in FIG. 6, the adjustment data module 20 is a popular and personalized adjustment database under the standard flavor. More specifically, although the expert data module 10 can provide optimal coffee concentrate according to expert perspectives, the optimal flavor can vary among different users. Therefore, the adjustment data module 20 can serve as a subsequent adjustment database after the capsule coffee machine 200 obtains the coffee concentrate. The adjustment data module 20 includes a plurality of concentration adjustment data corresponding to the plurality of capsule identity data. Each of the concentration adjustment data can be used for adjustment by an external device 300 (as shown in FIG. 7, e.g., a mobile phone). That is to say, a user can establish a preferred concentration parameter (i.e., the concentration adjustment data) under a standard coffee concentrate through the external device 300, and store it in the adjustment data module 20 for subsequent use by the control module 40.

In one embodiment, the adjustment data module 20 includes an integration unit 210 that is electrically coupled to the expert data module 10 and an outputting sub-database 220 that is connected to the integration unit 210. Wherein the integration unit 210 is configured to be inputted to a personal concentration instruction corresponding to the capsule identity data through the external equipment 300, and the integration unit 210 is configured to generate the concentration adjustment data corresponding to the capsule identity data according to the personal concentration instruction for storage in the outputting sub-database 220.

In addition, the adjustment data module 20 can also be used as an initial flavor of the capsule coffee machine 200 according to the user's preference. Specifically, the adjustment data module 20 includes a collection unit 230 that is connected to the integration unit 210, an initial sub-database 240 that is connected to the collection unit 230, and an output unit 250 that is connected to the control module 40, the integration unit 210, and the initial sub-database 240. The collection unit 230 is configured to collect the personal concentration instructions corresponding to each of the capsule identity data through the integration unit 210 and is configured to store the personal concentration instructions in the initial sub-database 240. When the output unit 250 detects that the integration unit 210 has not received the personal concentration instruction from the external equipment 300, the output unit 250 is operable to select the personal concentration instruction corresponding to the capsule identity data from the initial sub-database 240 to generate the concentration adjustment data for storage in the outputting sub-database 220, but the present disclosure is not limited thereto.

For example, the collection unit 230 can also be connected to the capsule coffee machine of other users through the cloud to integrate the personal concentration instructions corresponding to each of the capsule identity data to create an initial flavor that is popular with the public.

Referring to FIG. 6 and FIG. 7, the identification module 30 is configured to compare the first coffee capsule 400 (currently brewed by the user) with the capsule identity data to select the concentration control command, the standard concentration data, and the concentration adjustment data corresponding to the first coffee capsule 400. In practice, the identification module 30 may be an image recognition camera, and the identification module 30 performs identification by recognizing an identification code (e.g., a one-dimensional code or a two-dimensional code) located on the first coffee capsule, but the present disclosure is not limited thereto. For example, in other embodiments of the present disclosure (not shown in the drawings), the identification module 30 of the capsule coffee machine 200 can be omitted and the function can be implemented by an image capturing lens of the external device 200 (e.g., a camera of a mobile phone).

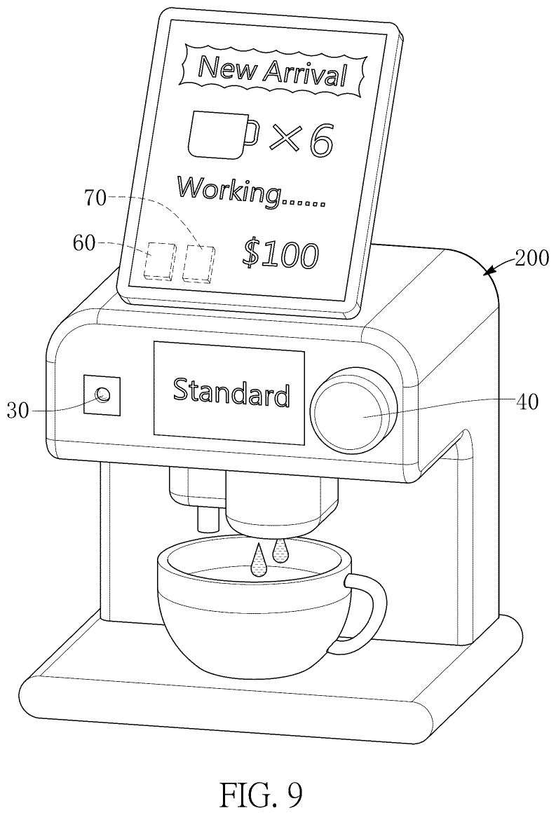

As shown in FIG. 6 and FIG. 9, the control module 40 is configured to receive the concentrate control command, the standard concentration data, and the concentration adjustment data, and the control module 40 is further configured to brew the first coffee capsule 400 with a first liquid having a first predetermined condition according to the concentrate control command to generate a coffee concentrate having a standard concentration corresponding to the standard concentration data. The first predetermined condition is set through the concentration adjustment command, and therefore the first predetermined condition can be understood as a brewing condition provided by the expert. Naturally, when the first liquid (e.g., drinking water) brews the first coffee capsule, the resulting coffee concentrate will inevitably correspond to the standard concentration data.

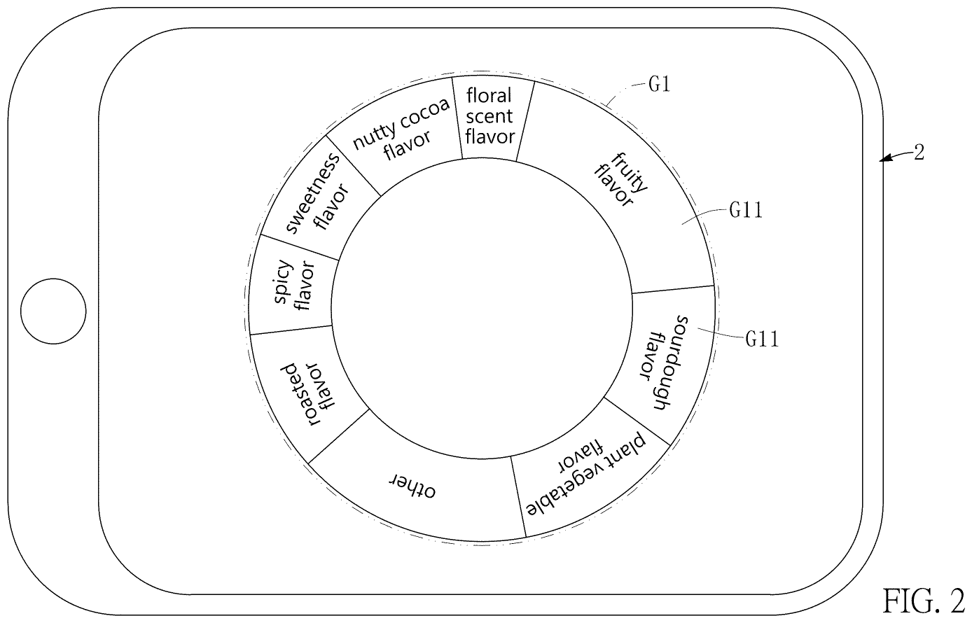

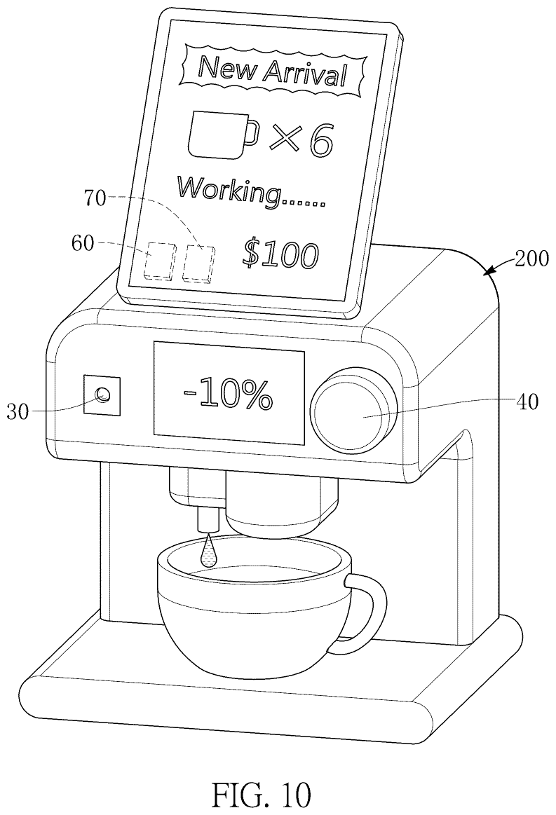

Furthermore, as shown in FIG. 2 and FIG. 10, the control module 40 is configured to input a second liquid having a second predetermined condition into the coffee concentrate according to the concentration adjustment data to generate an optimal-concentration beverage liquid. That is to say, after the control module 40 has finished brewing the coffee concentrate, the control module 40 further adjusts the coffee concentrate appropriately according to the personalized parameters (i.e., the concentration adjustment data) stored in the adjustment data module 20.

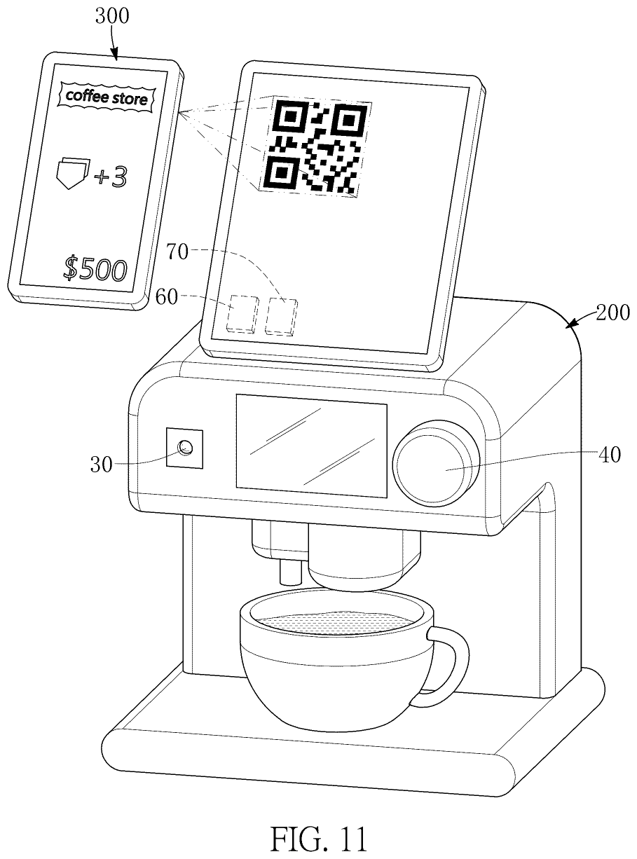

It should be noted that, in practice, the capsule coffee machine 200 can further push suitable capsule products and ordering services according to personal coffee preferences. Specifically, the capsule coffee machine 200 further includes an analysis module 50 that is electrically coupled to the identification module 30 and the control module 40 and a push notification module 60 that is electrically coupled to the analysis module 50. The analysis module 50 is configured to count the number of times that each of the capsule identity data is identified by the identification module 30 and the concentration adjustment data used corresponding to each of the first coffee capsules 400 to establish preference data. Accordingly, the push notification module 60 is configured to push personalized product information according to the preference data (as shown in FIG. 5, FIG. 6 and FIG. 11). That is to say, the personalized product information has a plurality of recommended first coffee capsule data. For example, the push notification module 60 can be an electronic display device configured to send audio and video corresponding to the personalized product information. Naturally, the “current coffee machine operation and brewing status” can also be presented in the same manner. For another example, the push notification module 60 is a communication software sending device configured to send text and images corresponding to the personalized product information.

In addition, the capsule coffee machine 200 further includes an ordering module 70 that is electrically coupled to the push notification module 60, the ordering module 70 includes a plurality of ordering links respectively corresponding to the plurality of recommended coffee capsule data, and each of the ordering links is configured to guide the external equipment 300 to order a capsule product corresponding to the recommended coffee capsule data.

Furthermore, it should be noted that, each of coffee capsules has a different flavor, and mixing at least two of the coffee capsules can provide different flavors. For example, the first coffee capsule 400 has floral and nutty flavors, but the user may wish for the optimal concentration beverage to also have a fruity flavor. Therefore, the capsule coffee machine 200 of the present disclosure can further brew a second coffee capsule (not shown) in the optimal concentration beverage to provide a customized flavor.

More specifically, the expert data module 10 further includes a plurality of flavor data corresponding to the capsule identity data. The adjustment data module 20 further includes a plurality of mixed flavor standard data, each of the mixed flavor standard data being established according to the flavor data and the standard concentration data corresponding to at least two of the capsule identity data. In practice, the mixed flavor standard data is generated by “optimizing the concentration and flavor results after brewing different flavor coffee capsules (coffee beans) according to different concentrations.”

The identification module 30 is configured to output the mixed flavor standard data including the capsule identity data matching the first coffee capsule 400 to the external equipment 300, such that the external equipment 300 is configured to selectively transmit one of the mixed flavor standard data to the control module 40 and is configured to define the mixed flavor standard data that is transmitted to the control module as a customized flavor data.

In other words, the identification module 30 can provide the mixed flavor standard data, including the first coffee capsule 400 and other coffee capsules to the external device 300 of the user. The user uses the external device 300 to select a preferred flavor (i.e., the customized flavor data) from the mixed flavor standard data.

The control module 40 is configured to input a third liquid having a third predetermined condition to brew a second coffee capsule into the optimal-concentration beverage liquid, thereby generating an optimal-flavor beverage liquid. The second coffee capsule is configured to match the capsule identity data corresponding to the customized flavor data, and the third predetermined condition is configured to satisfy the standard concentration data corresponding to the customized flavor data.

That is to say, the control module 40 selects the second coffee capsule that can achieve (or match) the customized flavor data. The control module 40 is configured to brew the second coffee capsule according to the optimized concentration and flavor, and adds it to the optimal concentration beverage to obtain an optimally flavored beverage.

### Fourth Embodiment

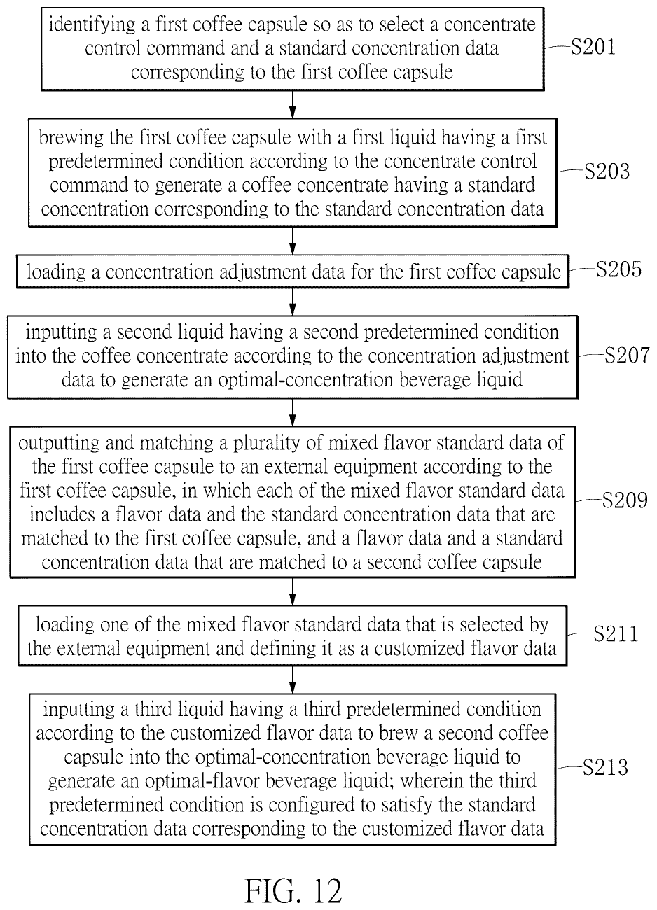

Referring to FIG. 12, the present embodiment provides a brewing and management method that supports personal comfortable flavor, which can be applied to the capsule coffee machine 200 of the third embodiment or to any other capsule coffee machine. The brewing and management method includes steps S201 to S207.

Step S201: identifying a first coffee capsule so as to select a concentrate control command and a standard concentration data corresponding to the first coffee capsule.

Step S203: brewing the first coffee capsule with a first liquid having a first predetermined condition according to the concentrate control command to generate a coffee concentrate having a standard concentration corresponding to the standard concentration data.

Step S205: loading a concentration adjustment data for the first coffee capsule.

Step S207: inputting a second liquid having a second predetermined condition into the coffee concentrate according to the concentration adjustment data to generate an optimal-concentration beverage liquid.

Preferably, the brewing and management method that supports personal comfortable flavor further includes the following steps in order to add different coffee flavors:
Step S209: outputting and matching a plurality of mixed flavor standard data of the first coffee capsule to an external equipment according to the first coffee capsule, in which each of the mixed flavor standard data includes a flavor data and the standard concentration data that are matched to the first coffee capsule, and a flavor data and a standard concentration data that are matched to a second coffee capsule.

Step S211: loading one of the mixed flavor standard data that is selected by the external equipment and defining it as a customized flavor data.

Step S213: inputting a third liquid having a third predetermined condition according to the customized flavor data to brew a second coffee capsule into the optimal-concentration beverage liquid to generate an optimal-flavor beverage liquid; wherein the third predetermined condition is configured to satisfy the standard concentration data corresponding to the customized flavor data.

### Beneficial Effects of the Embodiments

In conclusion, in the adaptive coffee supply system and method thereof provided by the present disclosure, by virtue of “the calculating module being configured to calculate a formula output data of the two harmonized flavor density data in the two output coffee data according to the two target flavor scores, and a product of the formula output data and each of the harmonized flavor density data being equal to the target flavor score,” and “the communication module being configured to transmit the two output coffee data and the two formula output data to a manufacturing equipment for producing an adaptive coffee,” the adaptive coffee supply system and method thereof can provide the adaptive coffee according to drinker's taste.

Furthermore, in the adaptive coffee supply system and method thereof provided by the present disclosure, a capsule coffee machine is further included, and by virtue of “the control module being further configured to brew the first coffee capsule with a first liquid having a first predetermined condition according to the concentrate control command to generate a coffee concentrate having a standard concentration corresponding to the standard concentration data,” and “the control module being configured to input a second liquid having a second predetermined condition into the coffee concentrate according to the concentration adjustment data to generate an optimal-concentration beverage liquid,” the capsule coffee machine can provide coffee with an optimal concentration based on individual needs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An adaptive coffee supply system, comprising:
a database including an adaptive flavor table and a plurality of coffee data, wherein the adaptive flavor table includes a plurality of different flavor data, and the coffee data includes a plurality of flavor density data corresponding to the flavor data;
an operating interface electrically coupled to the database, wherein the operating interface is configured to selectively output at least two of the flavor data and is configured to respectively define the flavor data as two designated flavor data, and the operation interface is configured to weight the two designated flavor data to obtain two target flavor scores;
a comparing module electrically coupled to the operating interface and the database, wherein the comparing module is configured to compare the coffee data according to the two designated flavor data to select at least two of the coffee data to be defined as two output coffee data; and wherein two of the flavor density data included in the two output coffee data correspond to the two designated flavor data and are defined as two harmonized flavor density data;
a calculating module electrically coupled to the comparing module, wherein the calculating module is configured to calculate a formula output data of the two harmonized flavor density data in the two output coffee data according to the two target flavor scores, and a product of the formula output data and each of the harmonized flavor density data is equal to the target flavor score; and
a communication module electrically coupled to the calculating module, wherein the communication module is configured to transmit the two output coffee data and the two formula output data to a manufacturing equipment for producing an adaptive coffee.

2. The adaptive coffee supply system according to claim 1, wherein the operating interface is configured to arrange the flavor data in a circular shape according to a sensory similarity, a chemical similarity, and an extraction-and-perception sequence.

3. The adaptive coffee supply system according to claim 1, wherein the adaptive coffee supply system further includes an adjusting module that is electrically coupled to the database and the operating interface, wherein the adjusting module is configured to classify the flavor data according to a sensory similarity, a chemical similarity, and an extraction-and-perception sequence, and the adjusting module is configured to exclude the flavor data having mutually exclusive characteristics according to the two designated flavor data, so as to adjust the adaptive flavor table.

4. The adaptive coffee supply system according to claim 1, wherein each of the flavor density data includes a flavor identity corresponding to the flavor data and a proportion coefficient value; and wherein the comparing module is configured to select the coffee data according to whether the flavor identity matches the designated flavor data, and the calculating module is configured to obtain the formula output data as a quotient value of the target flavor score and the proportion coefficient value.

5. The adaptive coffee supply system according to claim 4, wherein the proportion coefficient value of each of the flavor density data is 1.

6. The adaptive coffee supply system according to claim 4, wherein the adaptive coffee supply system further includes a correction module that is connected to the database, each of the coffee data further includes a volatile organic compound value and an ion value, and the correction module is configured to correct the proportion coefficient value according to the volatile organic compound value and the ion value of each of the coffee data.

7. The adaptive coffee supply system according to claim 4, wherein the adaptive coffee supply system further includes a capsule coffee machine, the capsule coffee machine includes:
an expert data module, wherein the expert data module includes a plurality of capsule identity data, a plurality of concentrate control commands respectively corresponding to the capsule identity data, and a plurality of standard concentration data respectively corresponding to the capsule identity data;
an adjustment data module, wherein the adjustment data module includes a plurality of concentration adjustment data respectively corresponding to the capsule identity data, and each of the concentration adjustment data is configured to be adjusted by an external equipment;
an identification module electrically coupled to the expert data module, wherein the identification module is configured to match a first coffee capsule through the capsule identity data so as to select the concentrate control command, the standard concentration data, and the concentration adjustment data corresponding to the first coffee capsule; and
a control module electrically coupled to the identification module and the adjustment data module, the control module is configured to receive the concentrate control command, the standard concentration data, and the concentration adjustment data, and the control module is further configured to brew the first coffee capsule with a first liquid having a first predetermined condition according to the concentrate control command to generate a coffee concentrate having a standard concentration corresponding to the standard concentration data, and wherein the control module is configured to input a second liquid having a second predetermined condition into the coffee concentrate according to the concentration adjustment data to generate an optimal-concentration beverage liquid.

8. The adaptive coffee supply system according to claim 7, wherein the capsule coffee machine includes an analysis module that is electrically coupled to the identification module and the control module and a push notification module that is electrically coupled to the analysis module, wherein the analysis module is configured to count the number of times each of the capsule identity data is identified by the identification module and the concentration adjustment data used corresponding to each of the first coffee capsules to establish preference data, and wherein the push notification module is configured to push personalized product information according to the preference data.

9. The adaptive coffee supply system according to claim 8, wherein the personalized product information includes a plurality of recommended coffee capsule data; and wherein the capsule coffee machine further includes an ordering module that is electrically coupled to the push notification module, the ordering module includes a plurality of ordering links respectively corresponding to the plurality of recommended coffee capsule data, and each of the ordering links is configured to guide the external equipment to order a capsule product corresponding to the recommended coffee capsule data.

10. The adaptive coffee supply system according to claim 7, wherein the adjustment data module includes an integration unit that is electrically coupled to the expert data module and an outputting sub-database that is connected to the integration unit, the integration unit is configured to be inputted to a personal concentration instruction corresponding to the capsule identity data through the external equipment, and the integration unit is configured to generate the concentration adjustment data corresponding to the capsule identity data according to the personal concentration instruction for storage in the outputting sub-database.

11. The adaptive coffee supply system according to claim 10, wherein the adjustment data module includes a collection unit that is connected to the integration unit, an initial sub-database that is connected to the collection unit, and an output unit that is connected to the control module, the integration unit, and the initial sub-database, wherein the collection unit is configured to collect the personal concentration instructions corresponding to each of the capsule identity data through the integration unit and is configured to store the personal concentration instructions in the initial sub-database, and wherein, when the output unit detects that the integration unit has not received the personal concentration instruction from the external equipment, the output unit is operable to select the personal concentration instruction corresponding to the capsule identity data from the initial sub-database to generate the concentration adjustment data for storage in the outputting sub-database.

12. The adaptive coffee supply system according to claim 7, wherein the expert data module further includes a plurality of flavor data corresponding to the capsule identity data; wherein the adjustment data module further includes a plurality of mixed flavor standard data, each of the mixed flavor standard data being established according to the flavor data and the standard concentration data corresponding to at least two of the capsule identity data; wherein the identification module is configured to output the mixed flavor standard data including the capsule identity data matching the first coffee capsule to the external equipment, such that the external equipment is configured to selectively transmit one of the mixed flavor standard data to the control module and is configured to define the mixed flavor standard data that is transmitted to the control module as a customized flavor data; wherein the control module is configured to input a third liquid having a third predetermined condition to brew a second coffee capsule into the optimal-concentration beverage liquid, thereby generating an optimal-flavor beverage liquid; and wherein the second coffee capsule is configured to match the capsule identity data corresponding to the customized flavor data, and the third predetermined condition is configured to satisfy the standard concentration data corresponding to the customized flavor data.

13. An adaptive coffee supply method, comprising:
loading an adaptive flavor table, wherein the adaptive flavor table includes a plurality of different flavor data;
displaying the adaptive flavor table on an operating interface, and selecting at least two of the flavor data via the operating interface to respectively define the flavor data as two designated flavor data;
weighting the two designated flavor data to obtain two target flavor scores;
loading a plurality of coffee data, each of the coffee data configured to correspond to a type of coffee grounds, wherein the coffee data includes a plurality of flavor density data corresponding to the flavor data;
selecting at least two of the coffee data to be defined as two output coffee data, wherein two of the flavor density data included in the two output coffee data correspond to the two designated flavor data and are defined as two harmonized flavor density data;
calculating a formula output data of the two harmonized flavor density data in the two output coffee data according to the two target flavor scores, and a product of the formula output data and each of the harmonized flavor density data being equal to the target flavor score; and
manufacturing an adaptive coffee according to the two output coffee data and the two formula output data.

14. The adaptive coffee supply method according to claim 13, wherein the operating interface is configured to arrange the flavor data in a circular shape according to a sensory similarity, a chemical similarity, and an extraction-and-perception sequence.

15. The adaptive coffee supply method according to claim 13, wherein classifying the flavor data according to a sensory similarity, a chemical similarity, and an extraction-and-perception sequence, and excluding the flavor data having mutually exclusive characteristics according to the two designated flavor data, so as to adjust the adaptive flavor table.

16. The adaptive coffee supply method according to claim 13, wherein the adaptive coffee supply method further includes a brewing and management method, the brewing and management method applied to a capsule coffee machine, and the brewing and management method comprising the following steps:
identifying a first coffee capsule so as to select a concentrate control command and a standard concentration data corresponding to the first coffee capsule;
brewing the first coffee capsule with a first liquid having a first predetermined condition according to the concentrate control command to generate a coffee concentrate having a standard concentration corresponding to the standard concentration data;
loading a concentration adjustment data for the first coffee capsule; and
inputting a second liquid having a second predetermined condition into the coffee concentrate according to the concentration adjustment data to generate an optimal-concentration beverage liquid.

17. The adaptive coffee supply method according to claim 16, wherein the brewing and management method further comprises the following steps:
outputting and matching a plurality of mixed flavor standard data of the first coffee capsule to an external equipment according to the first coffee capsule, wherein each of the mixed flavor standard data includes a flavor data and the standard concentration data that are matched to the first coffee capsule, and a flavor data and a standard concentration data that are matched to a second coffee capsule;
loading one of the mixed flavor standard data that is selected by the external equipment and defining one of the mixed flavor standard data as a customized flavor data; and
inputting a third liquid having a third predetermined condition according to the customized flavor data to brew a second coffee capsule into the optimal-concentration beverage liquid to generate an optimal-flavor beverage liquid;
wherein the third predetermined condition is configured to satisfy the standard concentration data corresponding to the customized flavor data.
